(19) United States
(12) Patent Application Publication
(10) Pub. No.: US 2018/0361703 A1
(43) Pub. Date: Dec. 20, 2018

(54) WOVEN FABRIC FOR BED SHEETS

(71) Applicant: GHCL Limited, Uttar Pradesh (IN)

(72) Inventor: Nancy Feldman, Woodbury, NY (US)

(21) Appl. No.: 15/627,519

(22) Filed: Jun. 20, 2017

(51) Int. Cl. B32B 5/02; D03D 13/00

(52) U.S. Cl. CPC B32B 5/024; B32B 2262/0276; D03D 13/008

(57) ABSTRACT

In a woven fabric the warp threads are woven in a weaving pattern in a warp direction of two warp threads up and then one down, adjacent columns in the weaving pattern being offset such that there are no rows in which the weft thread is always up. The warp threads are between 80 s and 100 s and the weft threads are between 60 s and 120 s. There are between 144 to 220 warp threads per inch of fabric and from 60 to 400 weft threads per inch of fabric. This fabric is smooth and soft like satin and durable like percale.

### FIELD OF INVENTION

The invention relates to woven fabrics that are used as bed sheets.

### BACKGROUND OF THE INVENTION

Bed sheets are made from a woven fabric material. In choosing a fabric for bed sheets manufacturers are looking for both comfort and durability. These properties are determined by not only the type of threads that are used to make the fabric, but also the manner in which the threads are woven together. There are numerous weave options that could be used to make bed sheets. Four common weave options are percale, satin, drill and twill.

The most common weave used for bed sheets is satin because of its smooth surface and soft and comfortable feel. However there is an inherent problem of durability of satin sheets. After being washed a few times the fabric becomes limp and generates a lot of pilling and lint formation. The interlacement of threads in a satin weave is very poor. For that reason there is more wear and tear during each wash in a satin fabric than occurs in other types of woven fabrics from which bed sheets are made.

Percale beds sheets are much more durable than satin sheets. But, percale has a peculiar problem of being too stiff. Also there is a limitation in terms of higher thread count. Many consumers believe that the higher the thread count in a bed sheet, the better the sheet. However, in percale the manufacturer normally cannot weave very high thread count. Finally, percale is not very soft and does not provide the luxury feel that consumers experience when using satin bed sheets.

Drill and twill are weaves that have traditionally been used to make woven fabrics from which clothing is made. But drill woven fabrics and twill woven fabrics are primarily used to make trousers and clothing used to cover a person's legs. Denim is made using drill weave or twill weave. But these weaves use thick yarns that result is a distinct texture on the fabric. Fabric woven using drill weaves or twill weaves usually does not feel smooth or soft. Because most consumers want their bed sheets to be smooth and soft, drill woven fabrics and twill woven fabrics have not been used for bed sheets.

Consequently, there is a need for a woven fabric that is both smooth and soft like satin and also durable like percale.

### SUMMARY OF THE INVENTION

I provide a woven fabric that is particularly suitable for bed sheets which has a smooth soft feel like satin and is also much more durable than satin. This fabric is created by using 60 s to 120 s weft threads and 80 s to 100 s warp threads in the weaving pattern described and illustrated herein. Furthermore, the number of weft threads is 60 to 400 per inch and the number of wrap threads is 144 to 220 per inch. The weaving pattern has more interlacements than satin but less interlacements than percale. In satin the weave pattern is 4 warp threads up and 1 down, and in percale the weave pattern is one up and one down. This present weave uses 2 warp threads up and one down.

Other features and advantages of my woven fabric for bed sheets will become apparent from a description of a certain present preferred embodiment thereof shown in the drawings.

### BRIEF DESCRIPTION OF THE DRAWING

FIG. 1 is an illustration of a weaving pattern known in the art in which the weft threads and the warp threads are identified.

FIG. 2 is a canvas representation of the weave pattern in FIG. 1.

FIG. 3 is a canvas representation of the weave pattern in the preferred embodiments of my woven fabric for bed sheets.

### DESCRIPTION OF THE PRESENT PREFERRED EMBODIMENTS

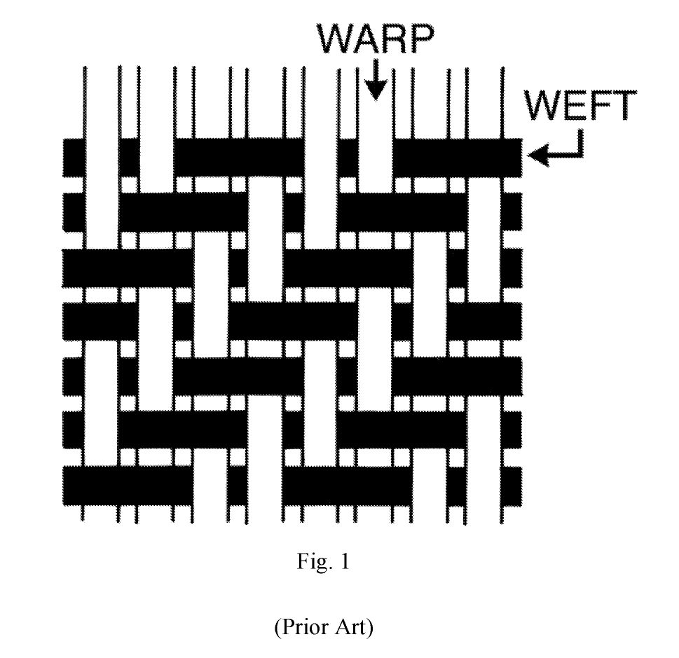

Woven fabric is made by weaving weft threads through a series of warp threads such that at each intersection of a warp thread and a weft thread, the warp thread will be on the top surface of the fabric and the weft thread will be on the bottom surface of the fabric, called warp overlap, or the weft thread will be on the top surface of the fabric and the warp thread will be on the bottom surface of the fabric, called weft overlap. FIG. 1 shows a weaving pattern known in the art in which eight warp threads and seven weft threads are shown.

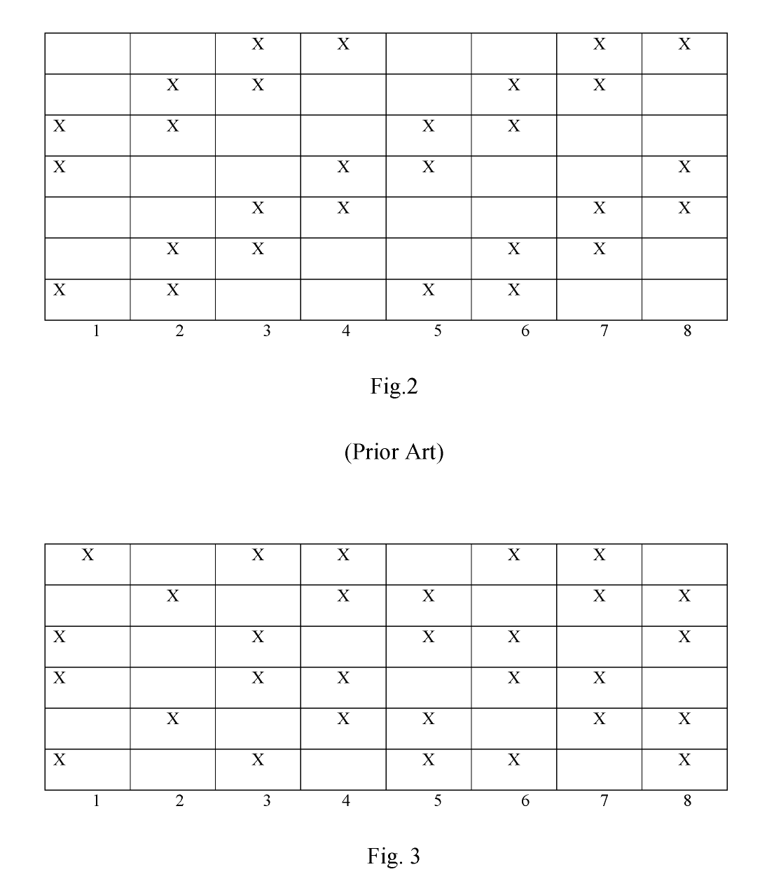

It is well known and quite common in the art to use a canvas, like a checkerboard, to illustrate a weaving pattern. Each square indicates an intersection of a weft thread and a warp thread. The presence of is an “x” or dot in the square indicates that warp thread is on the top surface of the fabric and the weft thread is on the bottom surface of the fabric, warp overlap. An empty square indicates that the weft thread is on the top surface of the fabric and the warp thread is on the bottom surface of the fabric, weft overlap. Interlacements occur where the warp thread and the weft thread change position, from being on the top surface to being on the bottom surface or vice versa. FIG. 2 is a canvas representation of the weave pattern shown in FIG. 1. Each of the warp threads are numbered in FIG. 2.

FIG. 3 shows the weaving pattern that is used in my woven fabric for bed sheets. In this weaving pattern warp threads 1 and 2 provide a selvedge. Then warp treads 3 through 8 are in the present preferred embodiment there are two warp threads up and then one down in the warp directions. In adjacent warp threads the pattern is offset such that there are no rows in which the weft thread is always up or always down.

Only fine threads are used in this woven fabric. The warp threads are between 80 s and 100 s. The weft threads are between 60 s and 120 s. There will be 144 to 220 warp threads per inch of fabric. The number of weft threads is 60 to 400 per inch.

By using fine weft threads and fine warp threads in the pattern shown in FIG. 3, I was able to achieve a durable woven fabric in which the bottom surface has a soft comfortable feel. This fabric does not have the pilling and lint formation problems of satin sheets.

A fabric made from 80 s cotton warp threads and 80 s cotton weft threads was made according to the fabric pattern shown in FIG. 3. Then this fabric was washed in a washing machine 5 times. After each washing the fabric was observed to see if any pilling had been formed. None was found after 5 washings. In contrast when a satin sheet was washed the same number of times, pilling formation occurred.

Although I prefer to make the fabric using cotton warp threads and cotton weft threads other types of thread could be used like polyester and rayon.

While I have described and illustrated certain pre sent preferred embodiments of woven fabric for bed sheets, the invention is not limited thereto but may be variously embodied within the scope of the following claims.

I claim:

1. A woven fabric comprised of warp threads and weft threads wherein:
the warp threads are woven in a weaving pattern in a warp direction of two warp threads up and then one down adjacent columns in the weaving pattern being offset such that there are no rows in which the weft thread is always up;
the warp threads being between 80 s and 100 s; and
the weft threads being between 60 s and 120 s.

2. The woven fabric of claim 1 wherein the weave pattern also comprises a selvedge.

3. The woven fabric of claim 1 comprising from 144 to 220 warp threads per inch of fabric.

4. The woven fabric of claim 1 comprising from 60 to 400 weft threads per inch of fabric.

5. The woven fabric of claim 1 wherein the warp threads are cotton and the weft threads are cotton, polyester or rayon.

6. The woven fabric of claim 1 comprised of 80 s cotton warp threads and 80 s cotton weft threads.
